(19) United States
(12) Patent Application Publication
(10) Pub. No.: US 2015/0116068 A1
(43) Pub. Date: Apr. 30, 2015

(54) COIL COMPONENT

(71) Applicant: SAMSUNG ELECTRO-MECHANICS CO., LTD., Suwon (KR)

(72) Inventors: Soon Young KWON, Suwon (KR); Duck Jin An, Suwon (KR); Eun Hee Yoon, Suwon (KR)

(73) Assignee: SAMSUNG ELECTRO-MECHANICS CO., LTD., Suwon (KR)

(21) Appl. No.: 14/147,837

(22) Filed: Jan. 6, 2014

(30) Foreign Application Priority Data
Oct. 31, 2013 (KR) 10-2013-0131339

(51) Int. Cl. H01F 5/02; H01F 27/29

(52) U.S. Cl. CPC H01F 5/02; H01F 27/29
USPC 336/192

(57) ABSTRACT

There is provided a coil component capable of easily securing insulation between external connection terminals and a core at the time of being manufactured at a small size. To this end, the coil component includes: a bobbin including a winding part having a coil wound therein and a terminal coupling part having at least one external connection terminal coupled thereto, the at least one external connection terminal having a lead wire of the coil connected thereto; and a core coupled to the bobbin and electromagnetically coupled to the coil, wherein the bobbin includes at least one spacing block protruding between the external connection terminal and the core and extending a creepage distance between the external connection terminal and the core.

### CROSS-REFERENCE TO RELATED APPLICATION

This application claims the benefit of Korean Patent Application No. 10-2013-0131339 filed on Oct. 31, 2013, with the Korean Intellectual Property Office, the disclosure of which is incorporated herein by reference.

### BACKGROUND

The present disclosure relates to a coil component, and more particularly, to a coil component capable of easily securing insulation between external connection terminals and a core at the time of being manufactured at a small size.

Various electronic devices such as television (TV), monitor, personal computer (PC), office automation (OA) device, and the like, require various forms of power supply. Therefore, these electronic appliances generally include power supplies converting alternating current (AC) power supplied from the outside into power required for each of the electronic appliances.

Among the power supplies, a power supply using a switching mode (for example, a switch mode power supply (SMPS)) has been mainly used in recent times. The SMPS basically includes a switching transformer.

Generally, the switching transformer may include a core and a bobbin with significantly decreased sizes as compared to a general transformer and may stably support low voltage and low current direct current (DC) power to the electronic appliances. Therefore, the switching transformer has been widely used in electronic appliances following a recent trend of miniaturization.

Meanwhile, in accordance with the miniaturization of electronic devices such as a display device or the like, power supplies or coil components mounted in the electronic devices have also been gradually miniaturized.

However, in the case in which the coil components are miniaturized, it may be difficult to secure insulation between primary and secondary sides. Particularly, in the case in which a core is disposed between primary and secondary external terminals, an insulation distance and a creepage distance between at least one of the primary and secondary external terminals and the core need to be secured.

However, as the coil component is miniaturized, the above-mentioned insulation distance may not be secured due to a manufacturing error, or the like, at the time of manufacturing a bobbin.

### RELATED ART DOCUMENT

(Patent Document 1) Japanese Patent Laid-Open Publication No. 2008-147265

### SUMMARY

An aspect of the present disclosure may provide a coil component capable of easily securing an insulation distance between a core and connecting terminals while having a small size.

According to an aspect of the present disclosure, a coil component may include: a bobbin including a winding part having a coil wound therein and a terminal coupling part having at least one external connection terminal coupled thereto, the at least one external connection terminal having a lead wire of the coil connected thereto; and a core coupled to the bobbin and electromagnetically coupled to the coil, wherein the bobbin may include at least one spacing block protruding between the external connection terminal and the core and extending a creepage distance between the external connection terminal and the core.

The winding part may include a tubular body part having the coil wound therearound and flange parts formed at both ends of the body part, and the spacing block may be formed on an outer surface of the flange part.

The external connection terminal may include primary and secondary external connection terminals, and the spacing block may be disposed between the core and the secondary external connection terminal.

The spacing block may be formed at a position spaced apart from the core by 1 mm or more.

The spacing block may protrude by a distance greater than equal to a distance by which the core protrudes from the bobbin.

The bobbin may include a through-hole into which the core is inserted, and the spacing block may be formed at a position spaced apart from the through-hole by 1 mm or more.

The bobbin may include a through-hole into which the core is inserted, the through-hole having a width wider than that of the core.

The bobbin may include a support protrusion disposed between the spacing block and the core and limiting a position of the core.

The core may be coupled to the bobbin at a position as distant from the spacing block as possible.

The bobbin may include a support protrusion limiting movement of the core.

The support protrusion may have a shape in which a cross-sectional area thereof becomes narrower toward an edge thereof.

The support protrusion may protrude from the spacing block.

According to another aspect of the present disclosure, a coil component may include: a bobbin including a winding part having a coil wound therein and a terminal coupling part having at least one external connection terminal coupled thereto, the at least one external connection terminal having a lead wire of the coil connected thereto; and a core coupled to the bobbin and electromagnetically coupled to the coil, wherein the winding part may include a through-hole into which the core is inserted, the through-hole having a width wider than that of the core, and the bobbin may include a support protrusion fixing the core while closely adhering the core to any one side in the through-hole.

The bobbin may include at least one spacing block protruding between the external connection terminal and the core and extending a creepage distance between the external connection terminal and the core.

The support protrusion may protrude from the spacing block.

The winding part may include a tubular body part having the coil wound therearound and flange parts formed at both ends of the body part, and the support protrusion may be formed on an outer surface of the flange part.

The support protrusion may have a shape in which a cross-sectional area thereof becomes narrower toward an edge thereof.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically showing a coil component according to an exemplary embodiment of the present disclosure;

FIG. 2 is an exploded perspective view of the coil component shown in FIG. 1;

FIG. 3 is a cross-sectional view of the coil component shown in FIG. 1;

FIG. 4 is a bottom perspective view schematically showing a bobbin of FIG. 2;

FIG. 5 is a perspective view schematically showing a coil component according to another exemplary embodiment of the present disclosure;

FIG. 6 is a cross-sectional view of the coil component shown in FIG. 5;

FIG. 7 is a bottom perspective view schematically showing a bobbin of the coil component shown in FIG. 5; and

FIGS. 8 through 12 are views showing various examples of a support protrusion of the coil component shown in FIG. 5.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein.

Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

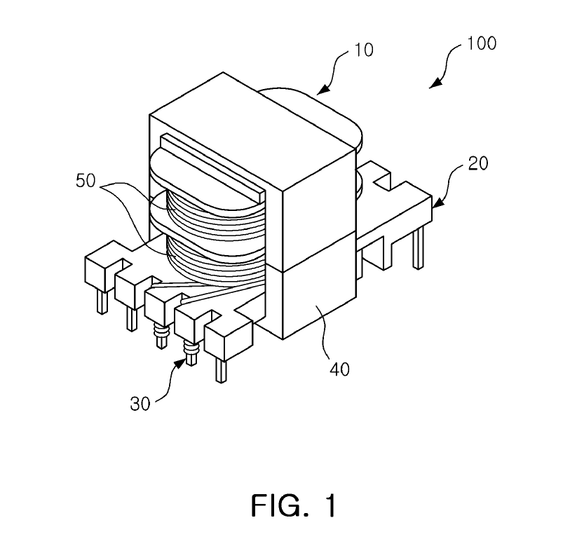

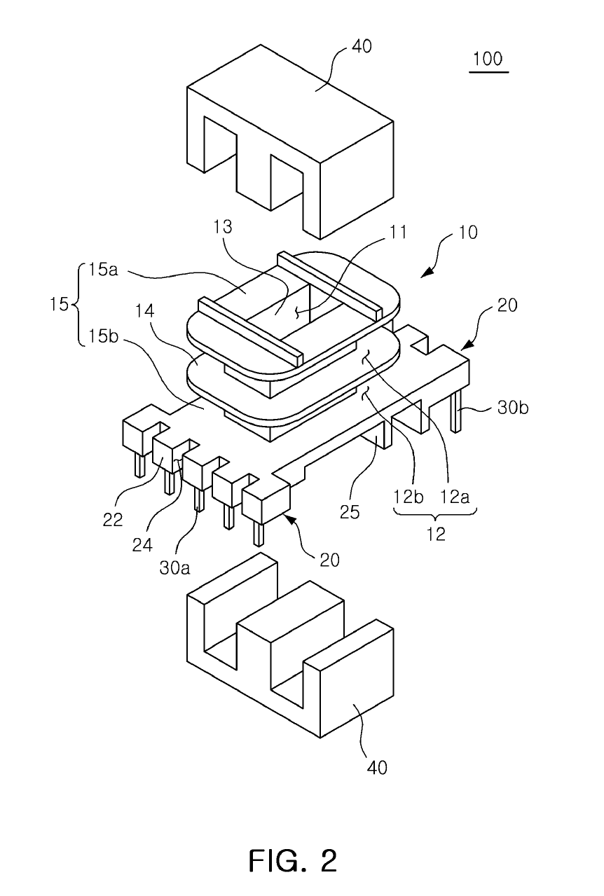

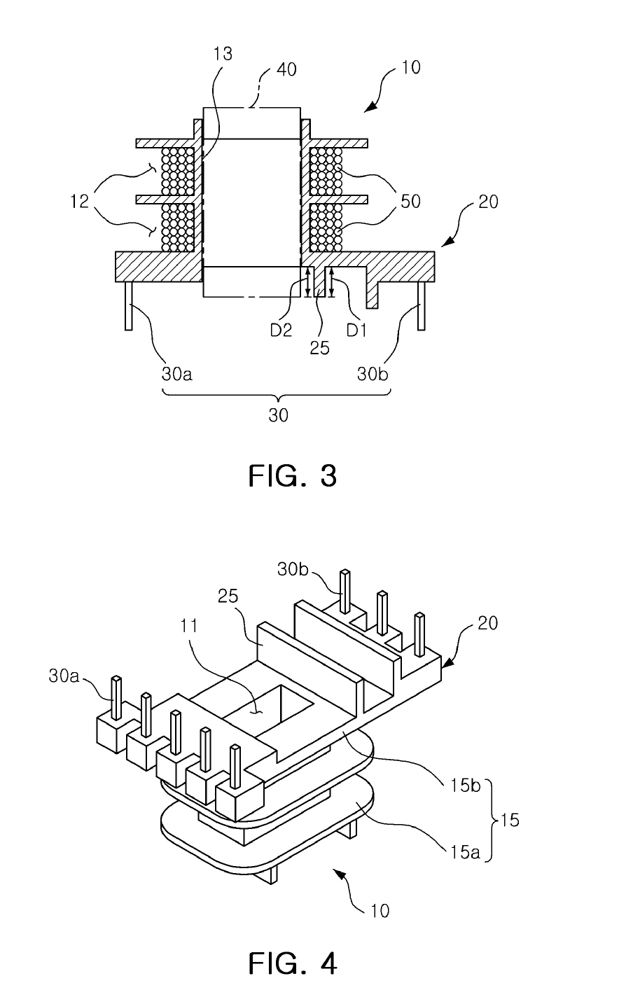

FIG. 1 is a perspective view schematically showing a coil component according to an exemplary embodiment of the present disclosure; and FIG. 2 is an exploded perspective view of the coil component shown in FIG. 1, omitting a coil. In addition, FIG. 3 is a cross-sectional view of the coil component shown in FIG. 1; and FIG. 4 is a bottom perspective view schematically showing a bobbin of FIG. 2.

Referring to FIGS. 1 through 4, the coil component 100 according to an exemplary embodiment of the present disclosure may be an insulating type switching transformer and may include a bobbin 10, a core 40, and a coil 50.

The bobbin 10 may form an entire body of the coil component 100. The bobbin 10 may be easily manufactured by injection molding, but is not limited thereto. In addition, the bobbin 10 according to the exemplary embodiment may be formed of an insulating resin, and may also be formed of a material having high heat resistance and high voltage resistance. An example of a material forming the bobbin may include polyphenylenesulfide (PPS), liquid crystal polyester (LCP), polybutyleneterephthalate (PBT), polyethyleneterephthalate (PET), phenolic resin, and the like.

The bobbin 10 may include a winding part 12 having the coil 50 wound therein and a terminal coupling part 20 formed at one end of the winding part 12.

The winding part 12 may include a body part 13 having a tubular shape and a flange part 15 extended from both ends of the body part 13 in an outer diameter direction of the body part 13.

The body part 13 may include a through-hole 11 formed therein and at least one partition wall 14 formed on an outer peripheral surface thereof, wherein the through-hole 11 includes the core 40 partially inserted thereinto and the partition wall 14 partitions a space in a length direction of the body part 13. In this configuration, the coil 50 may be wound in each of the spaces partitioned by the partition wall 14.

The winding part 12 according to the exemplary embodiment may include one partition wall 14. Therefore, the winding part 12 according to the exemplary embodiment may have two partitioned winding spaces 12a and 12b. However, the present disclosure is not limited thereto, and a plurality of partition walls 14 may be provided to form a plurality of spaces, if necessary.

The partition wall 14 may have various thicknesses and be formed of various materials as long as a form thereof is maintained. In addition, although the partition wall 14 has been described as being formed integrally with the bobbin 10 in the exemplary embodiment, the present disclosure is not limited thereto and may be variously applied. For example, the partition wall 14 may also be formed as a separate member and be coupled to the bobbin 10.

The partition wall 14 according to the exemplary embodiment as described above may have an approximately same shape as that of an upper flange part 15a to be described below.

The flange part 15 may protrude in a form in which it is extended from both ends, that is, upper and lower ends, of the body part 13 in the outer diameter direction of the body part 13. The flange part 15 according to the exemplary embodiment may be divided into an upper flange part 15a and a lower flange part 15b depending on positions thereof.

In addition, spaces between the outer peripheral surface of the body part 13 and the upper and lower flange parts 15a and 15b may be formed as winding spaces 12a and 12b in which the coils 50 are wound. Therefore, the flange part 15 may serve to protect the coil 50 from the outside and secure insulation properties between the coil 50 and the outside, while simultaneously serving to support the coils 50 wound in the winding spaces 12a and 12b at both side surfaces thereof.

The terminal coupling part 20 may be formed at the lower flange part 15b. More specifically, the terminal coupling part 20 according to the exemplary embodiment may protrude from the lower flange part 15b in the outer diameter direction in order to secure an insulation distance.

However, the present disclosure is not limited thereto; the terminal coupling part 20 may also protrude from the lower flange part 15b in a downward direction.

Meanwhile, referring to FIG. 2, since the terminal coupling part 20 according to the exemplary embodiment is partially extended from the lower flange part 15b, it may be difficult to clearly distinguish between the lower flange part 15b and the terminal coupling part 20. Therefore, the lower flange part 15b itself may also be considered the terminal coupling part 20 according to the exemplary embodiment.

External connection terminals 30 may be coupled to the terminal coupling part 20 in a form in which they protrude outwardly.

In addition, the terminal coupling part 20 according to the exemplary embodiment may be divided into a primary terminal coupling part and a secondary terminal coupling part depending on an order of the coil 50 connected to the external connection terminals 30.

In addition, the terminal coupling part 20 according to the exemplary embodiment may include a plurality of guide protrusions 22 and a plurality of guide grooves 24.

The plurality of guide protrusions 22 may protrude from a side of the terminal coupling part 20 in the outer diameter direction of the body part so as to be in parallel with each other.

The guide protrusions 22 may guide lead wires of the coil 50 wound in the winding part 12 so that the lead wires may be easily connected to the external connection terminals 30 at a lower portion of the terminal coupling part 20, as shown in FIG. 1. Therefore, the guide protrusions 22 may protrude at a size larger than or equal to a diameter of the lead wires of the coil 50 in order to firmly support and guide the coil 50 disposed.

The guide grooves 24 may be formed by the guide protrusions 22 and may be formed between the respective guide protrusions 22. Therefore, the guide grooves 24 according to the exemplary embodiment may be a plurality of independent grooves disposed between the respective external connection terminals 30.

The guide grooves 24 may be used as paths through which the lead wires of the coil 50 wound in the winding part 12 are led to the lower portion of the terminal coupling part 20. That is, the lead wires led from the winding part 12 may be inserted into the guide grooves 24, pass through the guide grooves 24, and then be connected to the external connection terminals 30. Therefore, the guide grooves 24 may have a width wider than a diameter of the coil 50.

The terminal coupling parts 20 may include a plurality of external connection terminals 30 coupled thereto. The external connection terminals 30 may protrude outwardly from the terminal coupling parts 20 and have various forms depending on a form or a structure of the coil component 100 or a structure of a substrate on which the coil component 100 is mounted.

The external connection terminals 30 may be divided into primary external connection terminals and secondary external connection terminals depending on an order of the coil coupled thereto. The coil component according to the exemplary embodiment shown in FIG. 4 describes the case in which five primary external connection terminals 30a and three secondary external connection terminals 30b are coupled to the terminal coupling part 20 by way of example.

However, in the coil component 100 according to the exemplary embodiment of the present disclosure, the number and the position of external connection terminals 30 are not limited to the above-mentioned configuration and may be changed as needed.

In addition, the lower flange part 15b according to the exemplary embodiment may include at least one spacing block 25 formed on an outer surface thereof.

The spacing block 25 may be formed at a position adjacent to the through-hole 11 on the outer surface, that is, a lower surface, of the lower flange part 15b. More specifically, the spacing block 25 according to the exemplary embodiment may be spaced apart from a core 40 to be described below by a predetermined distance at an outer side of the through-hole 11, protruding outwardly.

The exemplary embodiment describes the case in which the spacing block 25 protrudes between the secondary terminal coupling part 20 and the through-hole 11 by way of example. However, the present disclosure is not limited thereto. That is, the spacing block 25 may protrude between the primary terminal coupling part 20 and the through-hole 11, or the spacing blocks 25 may be formed at both sides.

That is, the spacing block 25 according to the exemplary embodiment may be formed at a position leaning toward any one of the primary and secondary external connection terminals 30a and 30b.

The spacing block 25 may secure an insulation distance and a creepage distance between the core 40 and the external connection terminals 30.

To this end, the spacing block 25 may protrude by a distance greater than or equal to a distance by which the core 40 protrudes from the lower flange part 15b. Therefore, a distance by which the spacing block 25 protrudes may be determined depending on a size of the core 40 coupled to the bobbin 10. In addition, the core 40 and the secondary external connection terminals 30b may secure an insulation distance therebetween through the spacing block 25.

Further, in order to secure a maximum creepage distance between the core 40 and the secondary external connection terminals 30b, the spacing block 25 may protrude at a position spaced apart from the core 40 by a predetermined distance. For example, the spacing block 25 and the core 40 may be spaced apart from each other by 1 mm or more. To this end, the spacing block 25 may be spaced apart from the through-hole 11 by 1 mm or more. However, the present disclosure is not limited thereto.

Referring to FIG. 3, in the case in which the spacing block 25 contacts the core 40, a creepage distance corresponding to a distance of D1 may be secured as compared with the related art in which the spacing block 25 is not present. However, a creepage distance between the core 40 and the secondary external connection terminals 30b corresponding to a distance of D1+D2 may be further secured in the case in which the spacing block 25 is spaced apart from the core 40 by a predetermined distance as in this exemplary embodiment, as compared with the case in which the spacing block 25 is not present. Therefore, insulation reliability may be improved.

The core 40 may be partially inserted into the through-hole 11 formed in the bobbin 10 and be electromagnetically coupled to the coil 50 to form a magnetic path.

The core 40 according to the exemplary embodiment may be configured as a pair. The pair of cores 40 may be partially inserted into the through-hole 11 of the bobbin 10 and thereby be coupled to each other so as to contact each other. The core 40 may be an “EE” core, an “EI” core, a “UU” core, a “UI” core, or the like, depending on a shape thereof.

The core 40 may be formed of Mn—Zn based ferrite having higher permeability, lower loss, higher saturation magnetic flux density, higher stability, and lower production costs, as compared with other materials. However, a shape or a material of the core 40 is not limited in the exemplary embodiment of the present disclosure.

The coil 50 may be wound in the winding part 12 of the bobbin 10 and include primary and secondary coils.

Each of the primary and secondary coils may include a plurality of individual coils that are electrically insulated from each other. However, the present disclosure is not limited thereto. That is, the number of individual coils of each of the primary and secondary coils may be appropriately changed as needed.

In addition, the primary coil may be connected to the primary external connection terminal 30a, and the secondary coil may be connected to the secondary external connection terminal 30b.

The primary and secondary coils according to the exemplary embodiment may be wound in the respective spaces partitioned by the partition wall 14. Therefore, insulation between the primary and secondary coils may be maintained by the partition wall 14.

Meanwhile, as the coil 50 according to the exemplary embodiment, a general insulated coil (for example, a polyurethane wire), or the like, or a twisted pair wire type coil formed by twisting several strands of wires (for example, a Litz wire) may be used. Alternatively, a multi-insulated coil (for example, a triple insulated wire (TIW)) having high insulation properties may be used. That is, the kind of coil may be selected as needed.

In the coil component according to the exemplary embodiment configured as described above, the insulation distance and the creepage distance between the core and the external connection terminals may be secured by the spacing block disposed between the core and the external connection terminals.

Therefore, even though the coil component is manufactured at a small size, a phenomenon that the coil component is manufactured so that the insulation distance or the creepage distance between the core and the external connection terminals becomes an allowable value or less due to a manufacturing error may be prevented.

Meanwhile, the present disclosure is not limited to the above-mentioned configuration, and may be variously applied as needed.

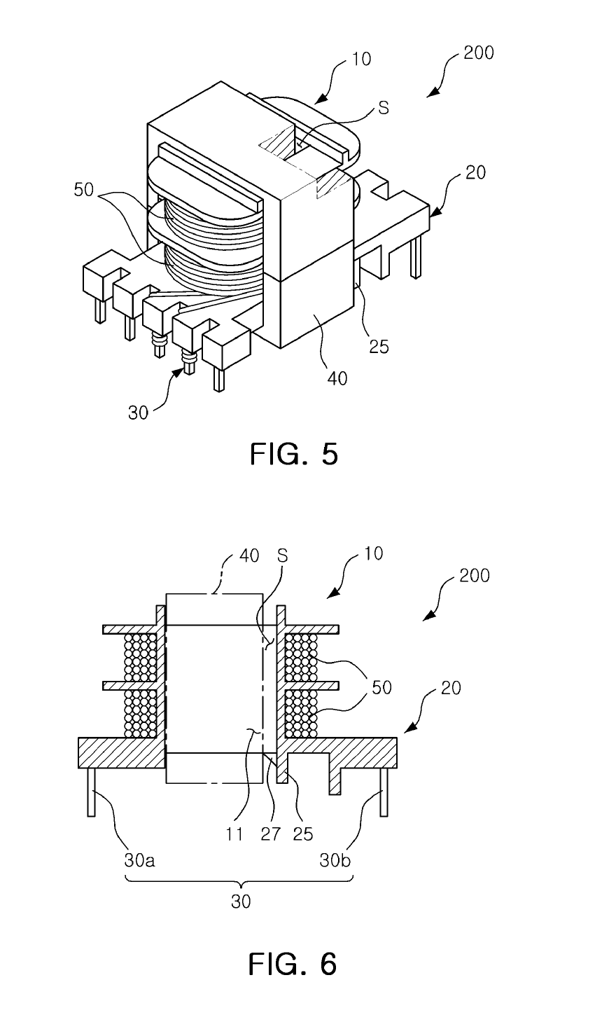

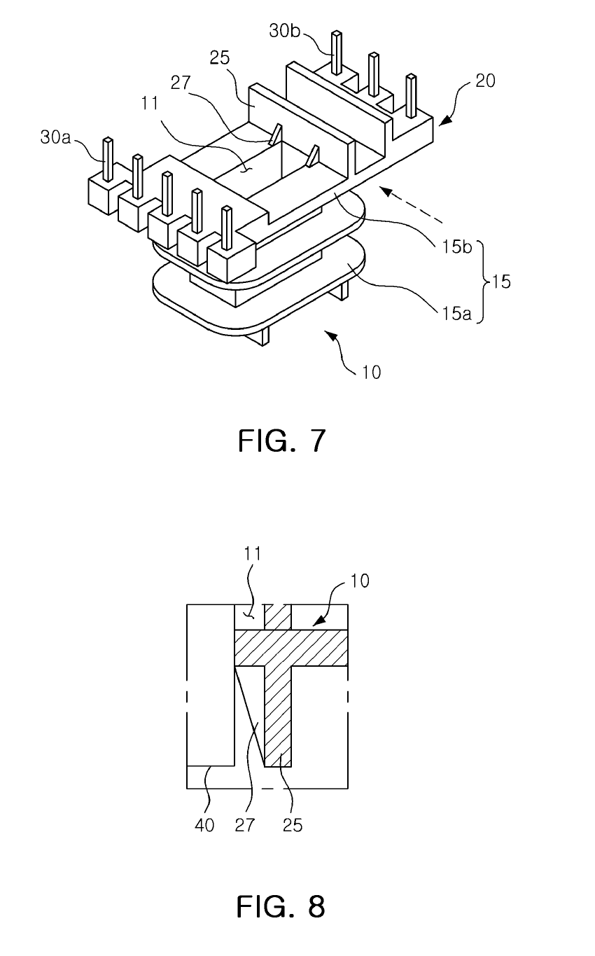

FIG. 5 is a perspective view schematically showing a coil component according to another exemplary embodiment of the present disclosure; FIG. 6 is a cross-sectional view of the coil component shown in FIG. 5; and FIG. 7 is a bottom perspective view schematically showing a bobbin of the coil component shown in FIG. 5.

Referring to FIGS. 5 through 7, in the coil component 200 according to the exemplary embodiment, the through-hole 11 may have a width wider than that of the core 40. Therefore, in the case in which the core 40 is coupled to the bobbin 10, an extra space S may be formed in the through-hole 11.

In addition, the coil component 200 according to the exemplary embodiment may include support protrusions 27 in order to allow the coil 50 to be spaced as far apart as possible from the secondary external connection terminals 30b.

The support protrusions 27 may protrude from a lower surface of the lower flange part 15b and fix a position of the core 40 coupled to the bobbin 10. More specifically, when the core 40 is coupled to the bobbin 10, the support protrusions 27 may limit the position of the core 40 to be as closely adhered to a primary side of the bobbin 10 as possible.

Therefore, the support protrusions 27 according to the exemplary embodiment may protrude from various positions of the bobbin 10 as long as they limit the position of the core 40. Although the exemplary embodiment describes the case in which the support protrusions 27 protrude from the lower surface of the lower flange part 15b by way of example, other various applications may be made. For example, the support protrusions 27 may protrude from an upper surface of the upper flange part 15a or a side of the partition wall.

In addition, the support protrusions 27 may have various shapes as long as they may limit movement and the position of the core 40.

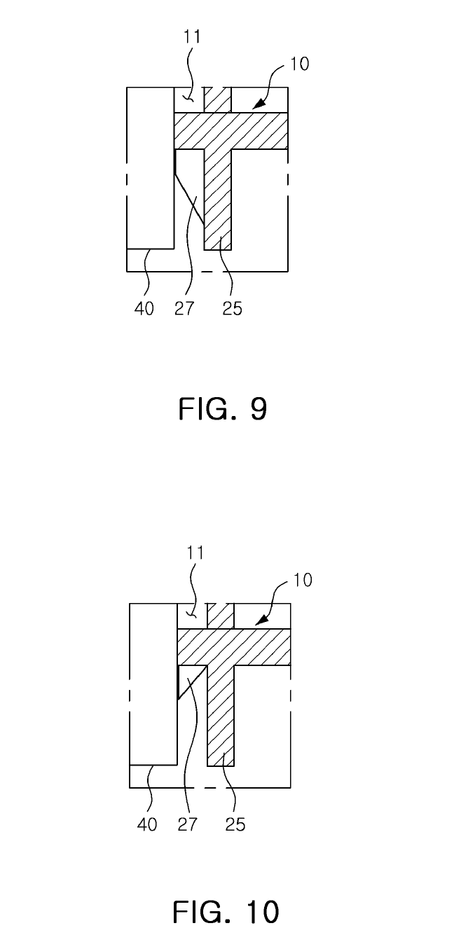

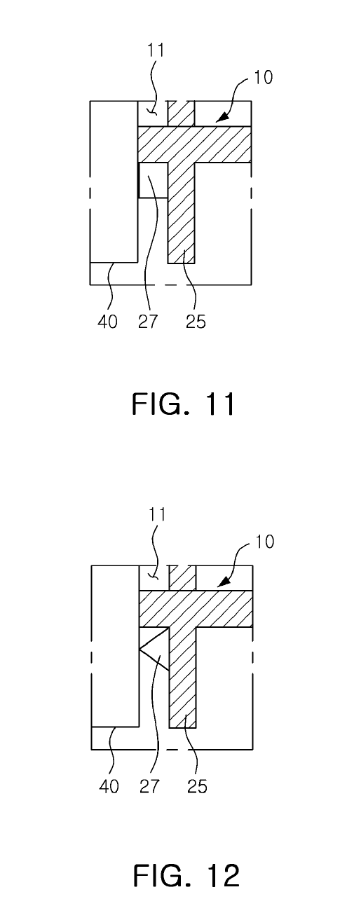

FIGS. 8 through 12 are views showing various examples of a support protrusion of the coil component shown in FIG. 5.

Referring to FIGS. 8 through 12, a support protrusion 27 according to an exemplary embodiment of the present disclosure may have a pointed shape in which a cross-sectional area thereof becomes narrower toward an outer side, that is, an edge thereof, as shown in FIGS. 8 through 10.

In addition, the support protrusion 27 may protrude from the flange part of the bobbin 10 as shown in FIGS. 8 through 11, or may protrude from the spacing block 25 as shown in FIG. 12.

The core 40 may be coupled to the bobbin 10 and moved as close to the primary side as possible by the support protrusion 27. Therefore, the core 40 and the secondary external connection terminals 30b may be spaced as far apart from each other as possible.

Therefore, in the coil component according to the exemplary embodiment, an insulation distance and a creepage distance may be more easily secured by the support protrusion 27 and the spacing block 25.

The coil component according to the present disclosure as described above is not limited to the above-mentioned exemplary embodiments, but may have various applications.

For example, although the present disclosure has described the case in which the terminal coupling part is disposed at the lower portion of the coil component by way of example, the terminal coupling part may also be disposed at an upper portion of the coil component.

In addition, although the above-exemplary embodiments have described the case in which the spacing block is formed between the secondary external connection terminals and the core, the present disclosure is not limited thereto. That is, the spacing block may also be formed between the primary external connection terminals and the core.

Further, although the exemplary embodiment has described the transformer by way of example, the present disclosure is not limited thereto, and may be widely applied to any coil component including a core and a coil.

In addition, the above-mentioned exemplary embodiments have described the insulating type switching transformer among the coil components by way of example. However, the present disclosure is not limited thereto, and may be variously applied to a component having a wound coil, such as a transformer for an inverter, a high frequency filter, or the like, and an electronic device including the same.

As set forth above, with a coil component according to exemplary embodiments of the present disclosure configured as described above, an insulation distance and a creepage distance between a core and external connection terminals may be secured by a spacing block disposed between the core and the external connection terminals.

In addition, the coil component according to exemplary embodiments of the present disclosure may include a support protrusion limiting the position of the core so that the core is coupled to a bobbin while being closely adhered to any one side (for example, primary side). Therefore, since the core is coupled to the bobbin and moved as close to the primary side as possible, the core and secondary external connection terminals are spaced as far apart from each other as possible, whereby the insulation distance and the creepage distance between the core and the external connection terminals may be secured.

Therefore, even though the coil component is manufactured at a small size, a phenomenon in which the coil component is manufactured so that the insulation distance or the creepage distance between the core and the external connection terminals falls under an allowable value due to a manufacturing error may be prevented.

While exemplary embodiments have been shown and described above, it will be apparent to those skilled in the art that modifications and variations could be made without departing from the spirit and scope of the present disclosure as defined by the appended claims.

What is claimed is:

1. A coil component, comprising:
a bobbin including a winding part having a coil wound therein and a terminal coupling part having at least one external connection terminal coupled thereto, the at least one external connection terminal having a lead wire of the coil connected thereto; and
a core coupled to the bobbin and electromagnetically coupled to the coil,
wherein the bobbin includes at least one spacing block protruding between the external connection terminal and the core and extending a creepage distance between the external connection terminal and the core.

2. The coil component of claim 1, wherein the winding part includes a tubular body part having the coil wound therearound and flange parts formed at both ends of the body part, and
the spacing block is formed on an outer surface of the flange part.

3. The coil component of claim 1, wherein the external connection terminal includes primary and secondary external connection terminals, and
the spacing block is disposed between the core and the secondary external connection terminal.

4. The coil component of claim 1, wherein the spacing block is formed at a position spaced apart from the core by 1 mm or more.

5. The coil component of claim 1, wherein the spacing block protrudes by a distance greater than or equal to a distance by which the core protrudes from the bobbin.

6. The coil component of claim 1, wherein the bobbin includes a through-hole into which the core is inserted, and
the spacing block is formed at a position spaced apart from the through-hole by 1 mm or more.

7. The coil component of claim 1, wherein the bobbin includes a through-hole into which the core is inserted, the through-hole having a width wider than that of the core.

8. The coil component of claim 7, wherein the bobbin includes a support protrusion disposed between the spacing block and the core and limiting a position of the core.

9. The coil component of claim 7, wherein the core is coupled to the bobbin at a position as distant from the spacing block as possible.

10. The coil component of claim 1, wherein the bobbin includes a support protrusion limiting movement of the core.

11. The coil component of claim 10, wherein the support protrusion has a shape in which a cross-sectional area thereof becomes narrower toward an edge thereof.

12. The coil component of claim 10, wherein the support protrusion protrudes from the spacing block.

13. A coil component, comprising:
a bobbin including a winding part having a coil wound therein and a terminal coupling part having at least one external connection terminal coupled thereto, the at least one external connection terminal having a lead wire of the coil connected thereto; and
a core coupled to the bobbin and electromagnetically coupled to the coil,
wherein the winding part includes a through-hole into which the core is inserted, the through-hole having a width wider than that of the core, and
the bobbin includes a support protrusion fixing the core while closely adhering the core to any one side in the through-hole.

14. The coil component of claim 13, wherein the bobbin includes at least one spacing block protruding between the external connection terminal and the core and extending a creepage distance between the external connection terminal and the core.

15. The coil component of claim 13, wherein the support protrusion protrudes from the spacing block.

16. The coil component of claim 13, wherein the winding part includes a tubular body part having the coil wound therearound and flange parts formed at both ends of the body part, and
the support protrusion is formed on an outer surface of the flange part.

17. The coil component of claim 13, wherein the support protrusion has a shape in which a cross-sectional area thereof becomes narrower toward an edge thereof.
